(19) United States
(12) Patent Application Publication
(10) Pub. No.: US 2017/0286755 A1
(43) Pub. Date: Oct. 5, 2017

(54) Facebot

(71) Applicant: Microsoft Technology Licensing, LLC, Redmond, WA (US)

(72) Inventor: Michael M.O. Kaletsky, London (GB)

(73) Assignee: Microsoft Technology Licensing, LLC, Redmond, WA (US)

(21) Appl. No.: 15/402,956

(22) Filed: Jan. 10, 2017

Related U.S. Application Data
(60) Provisional application No. 62/315,464, filed on Mar. 30, 2016.

(51) Int. Cl. G06K 9/00; G06F 17/27; H04L 12/58; G06F 17/24

(52) U.S. Cl. CPC G06K 9/00288; G06K 9/00228; G06F 17/24; G06F 17/2785; G06K 9/00302; H04L 51/02

(57) ABSTRACT

A software agent configured to perform operations of: receiving from a human user an image in a message within a communication event established between a user terminal associated with the human user and the software agent; transmitting image data from the image to at least three image processing service components, including: (i) first image processing service component for detecting physical characteristic of a facial image and providing raw data pertaining to physical characteristics; (ii) a second image processing service component for detecting emotional characteristics of a facial image and providing raw data pertaining to emotional characteristics; and (iii) a third image processing service component to detect whether an image is a facial image or a non-facial image and providing a probability indication; processing the raw data from the first and second image processing service and the probability indication from the third image processing service to generate humanly readable text for incorporation in a response message; transmitting the response message in the communication event to the user terminal for display to a human user at the user terminal.

### RELATED APPLICATIONS

This application claims priority under 35 U.S.C. 119(e) to U.S. Provisional Patent Application No. 62/315,464, filed Mar. 30, 2016 and titled “Facebot”, the entire disclosure of which is hereby incorporated by reference.

### BACKGROUND

Communication systems allow users to communicate with each other over a communication network e.g. by conducting a communication event over the network. The network may be, for example, the Internet or public switched telephone network (PSTN). During a call, audio and/or video signals can be transmitted between nodes of the network, thereby allowing users to transmit and receive audio data (such as speech) and/or video data (such as webcam video) to each other in a communication session over the communication network.

Such communication systems include Voice or Video over Internet protocol (VoIP) systems. To use a VoIP system, a user installs and executes client software on a user terminal. The client software sets up VoIP connections as well as providing other functions such as registration and user authentication. In addition to voice communication, the client may also set up connections for communication events, for instant messaging (“IM”), screen sharing, or whiteboard sessions.

A communication event may be conducted between a user(s) and an intelligent software agent, sometimes referred to as a “bot”. A software agent is an autonomous computer program that carries out tasks on behalf of users in a relationship of agency. The software agent runs continuously for the duration of the communication event, awaiting inputs which when detected, trigger automated tasks to be performed on those inputs by the agent. A software agent may exhibit artificial intelligence (AI), whereby it can simulate certain human intelligence processes, for example to generate human-like responses to inputs from the user, thus facilitating a two-way conversation between the user and the software agent via the network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect disclosed herein there is provided a computer program product comprising a software agent stored on computer readable storage (e.g. comprising a storage medium or multiple storage media), the software agent being configured when executed to perform operations of: receiving from a human user an image in a message within a communication event established between a user terminal associated with the human user and the software agent; transmitting image data from the image to at least two image processing service components, including: (i) first image processing service component for detecting physical characteristic of a facial image and providing raw data pertaining to physical characteristics; and (ii) a second image processing service component for detecting emotional characteristics of a facial image and providing raw data pertaining to emotional characteristics; processing the raw data from the first and second image processing service to generate humanly readable text for incorporation in a response message; transmitting the response message in the communication event to the user terminal for display to a human user at the user terminal.

In embodiments the method comprises supplying the image data to (iii) a third image processing service component to detect whether an image is a facial image or a non-facial image and receiving a probability indication from the third image processing service, wherein the image data is supplied to the first and second image processing services only if the probability indication indicates a probability above a threshold that the image is a facial image; and wherein said processing comprises processing the raw data from the first and second image processing service and the probability indication from the third image processing service to generate the humanly readable text for incorporation in the response message.

In embodiments, if the probability indication is below the threshold, the method comprises supplying the image data to a fourth image processing service which detects the nature of the image.

In embodiments, the step of processing the raw data comprises extracting characteristics from the raw data based on categories of expected characteristics, and accessing a library of characteristic terms to generate a humanly readable phrase or word matching the characteristic.

In embodiments, the method comprises accessing a semantics library of interconnecting phrases to generate the humanly readable text from the phrase or word.

In embodiments, the method comprises establishing the communication event in response to receiving a request from the user terminal.

In embodiments, the step of receiving the image data comprises extracting the image data from the received message.

In embodiments, the step of extracting the image data comprises extracting an indication from the message and using the indication to access a remote source of the image data.

According to another aspect disclosed herein, there is provided a computer device comprising a processor, a computer storage access component, and a communications interface, the processor configured to execute a computer program stored on storage accessed by the storage access component comprising a software agent (Bot), the software agent being configured when executed to perform operations of: receiving via the communications interface from a human user an image in a message within a communication event established between a user terminal associated with the human user and the software agent; transmitting image data from the image to at least two image processing service components, including: (i) first image processing service component for detecting physical characteristics of a facial image and providing raw data pertaining to physical characteristics; and (ii) a second image processing service component for detecting emotional characteristics of a facial image and providing raw data pertaining to emotional characteristics; processing the raw data from the first and second image processing service to generate humanly readable text for incorporation in a response message; transmitting the response message in the communication event to the user terminal for display to a human user at the user terminal.

In embodiments, the method comprises supplying the image data to (iii) a third image processing service component to detect whether an image is a facial image or a non-facial image and receiving a probability indication from the third image processing service, wherein the image data is supplied to the first and second image processing services only if the probability indication indicates a probability above a threshold that the image is a facial image; and wherein said processing comprises processing the raw data from the first and second image processing service and the probability indication from the third image processing service to generate the humanly readable text for incorporation in the response message.

In embodiments, if the probability indication is below the threshold, the method comprises supplying the image data to a fourth image processing service which detects the nature of the image.

In embodiments, the step of processing the raw data comprises extracting characteristics from the raw data based on categories of expected characteristics, and accessing a library of characteristic terms to generate a humanly readable phrase or word matching the characteristic, the library accessible via the storage access component.

In embodiments, the method comprises accessing a semantics library of interconnecting phrases to generate the humanly readable text from the phrase or word.

In embodiments, the method comprises establishing the communication event in response to receiving a request from the user terminal.

In embodiments, the step of receiving the image data comprises extracting the image data from the received message.

In embodiments, the step of extracting the image data comprises extracting an indication from the message and using the indication to access a remote source of the image data.

According to another aspect disclosed herein, there is provided a method implemented by a computer program product comprising a software agent stored on computer readable storage, the method comprising: receiving from a human user an image in a message within a communication event established between a user terminal associated with the human user and the software agent; transmitting image data from the image to at least two image processing service components, including: (i) first image processing service component for detecting physical characteristics of a facial image and providing raw data pertaining to physical characteristics; and (ii) a second image processing service component for detecting emotional characteristics of a facial image and providing raw data pertaining to emotional characteristics; processing the raw data from the first and second image processing service to generate humanly readable text for incorporation in a response message; transmitting the response message in the communication event to the user terminal for display to a human user at the user terminal.

In embodiments, the method comprises supplying the image data to (iii) a third image processing service component to detect whether an image is a facial image or a non-facial image and receiving a probability indication from the third image processing service, wherein the image data is supplied to the first and second image processing services only if the probability indication indicates a probability above a threshold that the image is a facial image; and wherein said processing comprises processing the raw data from the first and second image processing service and the probability indication from the third image processing service to generate the humanly readable text for incorporation in the response message.

In embodiments, if the probability indication is below the threshold, the method comprises supplying the image data to a fourth image processing service which detects the nature of the image.

In embodiments, the step of processing the raw data comprises extracting characteristics from the raw data based on categories of expected characteristics, and accessing a library of characteristic terms to generate a humanly readable phrase or word matching the characteristic.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF FIGURES

For a better understanding of the present subject matter and to show how the same may be carried into effect, reference is made by way of example to the following figures, in which:

FIG. 1 shows a schematic block diagram of a communication system;

FIG. 2 shows a schematic block diagram of a user terminal;

FIG. 3 shows a schematic block diagram of a remote system;

### DETAILED DESCRIPTION OF EMBODIMENTS

In the described embodiments a user(s) can have a conversation with a software agent over a communications network within a communication system, for example in an IM call.

An aim of the present disclosure is to provide an artificially intelligent software agent (bot) with access to a, potentially external, service such as an image processing service. The agent receives messages from a human user, and uses the service to process the message in order to generate an output. The bot then uses the output to generate a humanly readable message which is sent to the user as a response to the initial message sent to the bot by the user.

A context in which the techniques may be implemented is described.

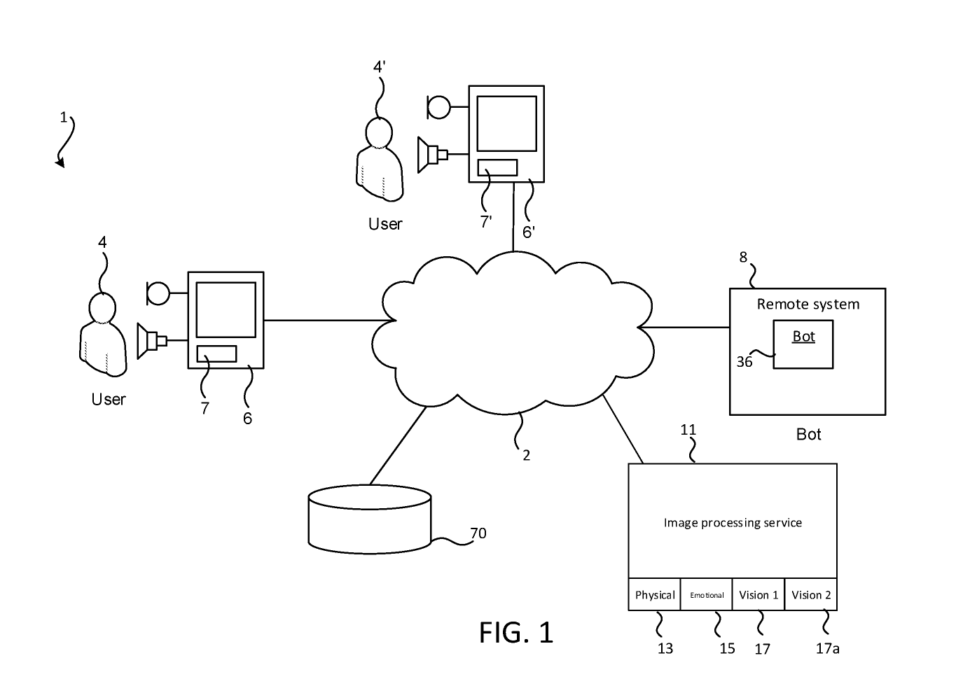

FIG. 1 shows a block diagram of a communication system 1. The communication system 1 comprises a communications network 2, to which is connected a first user terminal 6, a second user terminal 6′, a remote computer system 8 (remote from the user terminals 6, 6′), and a user account database 70. The network 2 is a packet-based network, such as the Internet.

The user terminals 6, 6′ are available to first and second users 4, 4′ respectively. Each user terminals 6, 6′ is shown to be executing a respective version of a communication client 7, 7′.

Each client 7, 7′ is for effecting communication events within the communications system via the network, such as instant messaging, audio and/or video calls, and/or other communication event(s) such as a whiteboard or screen sharing sessions, between the user 4 and the other user 4′. The communication system 1 may be based on voice or video over internet protocols (VoIP) systems. The client software sets up communication events (e.g. IM connections) as well as providing other functions such as registration and user authentication e.g. based on login credentials such as a username and associated password.

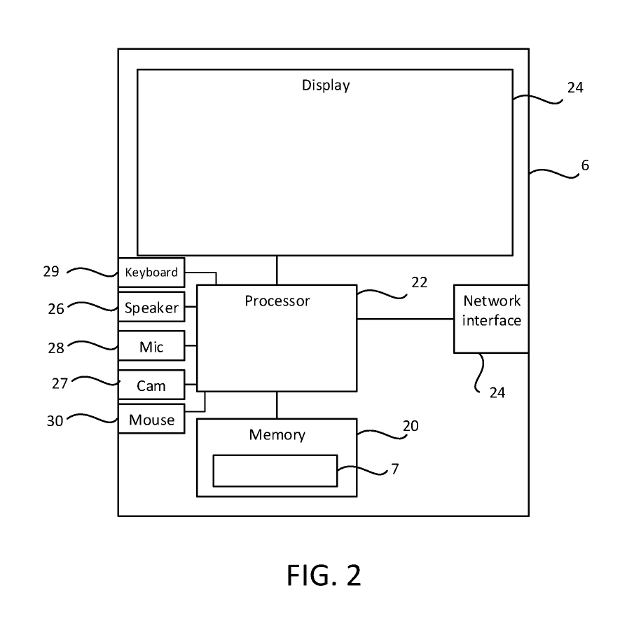

To effect a communication event, data (e.g. text messages, images, etc.) is captured from each of the users at their respective device and transmitted to the other user's device for outputting to the other user. For example, in an IM, the data comprises text data captured via a keyboard 29 (FIG. 2) of the respective device (or input via voice-to-text technology using microphone 28) and is transmitted as a data stream via the network 2, and may additionally comprise other data such as video data captured via a camera 27 of the respective device and embodying a moving image of that user (call video) transmitted as a video stream via the network 2. Another possibility is for a user to send images via the communications event. In this case, a user may user the mouse 30 and/or keyboard 29 to send an image or image data to another user using their client 7 (e.g. by “dragging and dropping” an image icon in to the IM chat as displayed on display 24). In any case, data are captured and encoded at the transmitting device before transmission, and decoded and outputted at the other device upon receipt. The users 4, 4′ can thus communicate with one another via the communications network 2.

A communication event may be real-time in the sense that there is at most a short delay, for instance about 2 seconds or less, between data (e.g. messages) being captured from one of the users at their device and the captured data being outputted to the other user at their device.

Only two users 4, 4′ of the communication system 1 are shown in FIG. 1, but as will be readily appreciated there may be many more users of the communication system 1, each of whom operates their own device(s) and client(s) to enable them to communicate with other users via the communication network 2. For example, group communication events, such as group calls (e.g. group IM chats), may be conducted between three or more users of the communication system 1.

FIG. 2 shows a block diagram of the user terminal 6. The user terminal 6 is a computer device which can take a number of forms e.g. that of a desktop or laptop computer device, mobile phone (e.g. smartphone), tablet computing device, wearable computing device (headset, smartwatch etc.), television (e.g. smart TV) or other wall-mounted device (e.g. a video conferencing device), set-top box, gaming console, etc. The user terminal 6 comprises a processor 22, formed on one or more processing units (e.g. CPUs, GPUs, bespoke processing units, etc.) and the following components, which are connected to the processor 22: memory 20, formed on one or more memory units (e.g. RANI units, direct-access memory units, etc.); a network interface(s) 24; at least one input device, e.g. a keyboard 29, mouse 30, camera 27 and microphone(s) 28 as shown; at least one output device, e.g. a loudspeaker (26) and a display(s) 24. The user terminal 6 connects to the network 2 via its network interface 24, so that the processor 22 can transmit and receive data to/from the network 2. The network interface 24 may be a wired interface (e.g. Ethernet, FireWire, Thunderbolt, USB, etc.) or wireless interface (e.g. Wi-Fi, Bluetooth, NFC, etc.). The memory holds the code of the communication client 7 for execution on the processor 22. The client 7 may be e.g. a stand-alone communication client application, plugin to another application such as a Web browser, etc. that is run on the processor in an execution environment provided by the other application. The client 7 has a user interface (UI) for receiving information from and outputting information to the user 4. For example, the client 7 can output decoded IM messages via the display 24. The display 24 may comprise a touchscreen so that it also functions as an input device. For audio/video calls, the client captures call audio/video via the microphone 28 and camera 27 respectively, which it encodes and transmits to one or more other user devices of other user(s) participating in a call. Any of these components may be integrated in the user device 6, or external components connected to the user device 6 via a suitable external interface.

Returning to FIG. 1, the user account database 70 stores, for each user of the communication system 1, associated user account data in association with a unique user identifier of that user. Thus users are uniquely identified within the communication system 1 by their user identifiers, and rendered ‘visible’ to one another within the communication system 1 by the database 70, in the sense that they are made aware of each other's existence by virtue of the information held in the database 70. The database 70 can be implemented in any suitable manner, for example as a distributed system, whereby the data it holds is distributed between multiple data storage locations.

The communication system 1 provides a logic mechanism, whereby users of the communication system can create or register unique user identifiers for themselves for use within the communication system, such as a username created within the communication system or an existing email address that is registered within the communication system as used as a username once registered. The user also creates an associated password, and the user identifier and password constitute credentials of that user. To gain access to the communication system 1 from a particular device, the user inputs their credentials to the client on that device, which is verified against that user's account data stored within the user account database 70 of the communication system 1. Users are thus uniquely identified by associated user identifiers (within the communication system 1). This is exemplary, and the communication system 1 may provide alternative or additional authentication mechanism, for example based on digital certificates.

At a given time, each username can be associated within the communication system with one or more instances of the client at which the user is logged. Users can have communication client instances running on other devices associated with the same log in/registration details. In the case where the same user, having a particular username, can be simultaneously logged in to multiple instances of the same client application on different devices, a server (or similar device or system) is arranged to map the username (user ID) to all of those multiple instances but also to map a separate sub-identifier (sub-ID) to each particular individual instance. Thus the communication system is capable of distinguishing between the different instances whilst still maintaining a consistent identity for the user within the communication system.

In addition to authentication, the client 7, 7′ provide additional functionality within the communication system, such as presence and contact-management mechanisms. The former allows users to see each other's presence status (e.g. offline or online, and/or more detailed presence information such as busy, available, inactive, etc.). The latter allows users to add each other as contacts within the communication system. A user's contacts are stored within the communication system 1 in association with their user identifier as part of their user account data in the database 70, so that they are accessible to the user from any device at which the user is logged on. To add another user as a contact, the user uses their client 7 to send a contact request to the other user. If the other user accepts the contact request using their own client, the users are added to each other's contacts in the database 70. Contacts are displayed to a user on the display of their user terminal: a user may see contacts that are real humans or contacts that represent bots, including the facial recognition bot described herein.

The remote system 8 is formed of a server device, or a set of multiple inter-connected server devices which cooperate to provide desired functionality. For example, the remote system 8 may be a cloud-based computer system, which uses hardware virtualization to provide a flexible, scalable execution environment, to which code modules can be uploaded for execution.

The remote computer system 8 implements an intelligent software agent (“Bot”) 36, the operation of which will be described in due course. Suffice it to say, the Bot 36 is an artificial intelligence software agent configured so that, within the communication system 1, it appears substantially as if it were if another member of the communication system. In this example, Bot 36 has its own user identifier within the communication system 1, whereby the user 4 can (among other things): receive or instigate calls from/to, and/or IM sessions with, the Bot 36 using their communication client 7, just as they can receive or instigate calls from/to, and/or IM sessions with, other user 4′ of the communication system 1; add the Bot 36 as one of their contacts within the communication system 1. In this case, the communication system 1 may be configured such that any such request is accepted automatically; see the bot's presence status. This may for example be “online” all or most of the time, except in exceptional circumstances (such as system failure).

This allows users of the communication system 1 to communicate with the Bot 36 by exploiting the existing, underlying architecture of the communication system 1. No or minimal changes to the existing architecture are needed to implement this communication. The bot thus appears in this respect as another user ‘visible’ within the communication system, just as users are ‘visible’ to each other by virtue of the database 70, and presence and contact management mechanisms.

The Bot 36 not only appears as another user within the architecture of the communication system 1, it is also programmed to simulate certain human behaviours. In particular, the Bot 36 is able to interpret the user's input, and respond to it in an intelligent manner. The Bot 36 formulates its responses as synthetic words/sentences, that are transmitted back to the user as messages and displayed out to user by the display 24 of their client 7 just as a real user's messages would be.

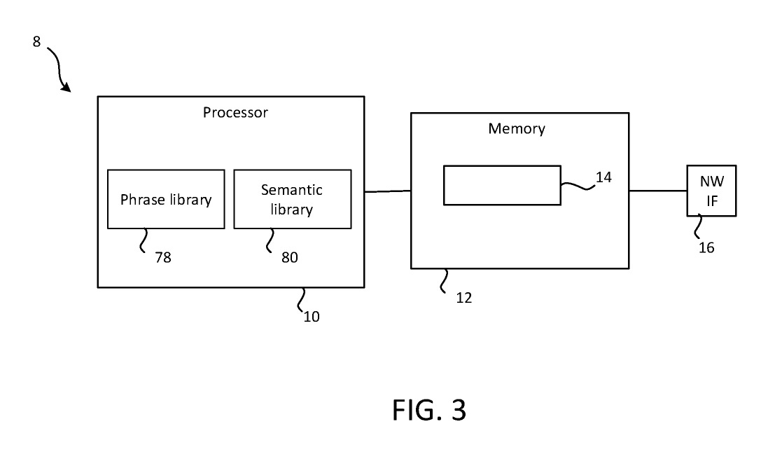

FIG. 3 shows a block diagram of the remote system 8. The remote system 8 is a computer system, which comprises one or more processors 10 (each formed of one or more processing units), memory 12 (formed of one or more memory units, which may be localized or distributed across multiple geographic locations) and a network interface 16 connected to the memory 12. The memory holds code 14 for execution on the processor 10. The code 14 includes the code of the software agent 36. The remote system connects to the network 2 via the network interface 16. As will be apparent, the remote system 8 may have a more complex hardware architecture than is immediately evident in FIG. 3. For example, as indicated, the remote system 8 may have a distributed architecture, whereby different parts of the code 14 are executed on different ones of a set of interconnected computing devices e.g. of a cloud computing platform.

In accordance with the present invention, the Bot 36 may be configured to provide special functionality, as outlined in more detail below.

Referring again to FIG. 1, it is understood that user 4 may, by way of his user terminal 6, instigate a communication event with the Bot (artificial intelligence software agent) 36. In this sense, the user 4 may “chat” with the Bot 36 through his client 7 in substantially the same way as he may chat with another (human) user such as user 4′ in previous examples.

Bot 36 may have access to services such as image processing service 11. These services may be external (e.g. third party services) and hence accessed via the network 2 (or another, separate network) as shown in FIG. 1, but it is appreciated that the services may be provided by functionality which is local to the Bot 36, e.g. embodied on remote system 8. When the service is a local service, the service may be accessed directly by the Bot 36 instead of via a network (not shown in FIG. 1).

As mentioned above, the user 4 may send images via IM chat to another user. Note that the user 4 may send image files themselves (potentially compressed, as is known in the art) or may simply send a reference to an image (e.g. a hyperlink) in which case the other user can retrieve the intended image. The term “image data” is used herein to refer to either the image file itself or a reference thereto.

As the Bot 36 effectively emulates a human user, it is understood that the user 4 may also send image data via IM chat to the Bot 36. Hence, the Bot 36 can be configured to perform actions in relation to the image and provide a response to the user 4. The present disclosure relates to a scenario in which the Bot 36 is arranged to use image processing service 11 to process an image received from a user and based on an output thereof to generate a human-readable response to the user. For example, the user 4 may send an image of their face to the Bot 36. The Bot 36 then uses image processing software 11 to process this image in order to analyse the image. Examples of image analysis techniques are known in the art which allow characteristics of the image to be determined such as physical characteristics (does the person have a moustache, is their hair brown, etc.) and emotional characteristics (does the person look happy/sad, etc.). Based on the output of the image analysis service, the Bot 36 generates a response for providing to the user 4 in the IM session. For example, the Bot 36 may comment on the user's emotional or physical characteristics in a humanly readable form (e.g. “you look happy”, etc.).

When the Bot 36 receives an image from the user 4, it is able to provide the image directly to image processing software 11. When the Bot 36 receives only an indication of an image (e.g. a hyperlink) from the user 4, it first retrieves the image from the indicated source (e.g. from the website via the internet) and can then provide the image to image processing software 11. Either way, the image processing software 11 is provided with the image which was intended by the user 4 and can process the image accordingly.

Image processing software 11 may contain various functionalities which may be presented as separate “services”. These provide remote image processing services by allowing users to remotely send images in over the internet for analysis by proprietary software running on a server. In the present invention, the Bot 36 is arranged to use these services to perform the image analysis.

Note that while image processing service 11 is shown in FIG. 1 as a separate entity from the user terminal 6 and remote system 8, it is not excluded that image processing service 11 may be implemented locally at either the remote system 8 (i.e. local to the Bot 36 itself) or the user terminal 6. Image processing software 11 may also be implemented in hardware or Programmable Silicon on Chip (PSoC).

FIG. 1 shows four examples of services provided by the image processing software 11. These are first image processing service component 13 for detecting physical characteristics of a facial image and providing raw data pertaining to physical characteristics; a second image processing service component 15 for detecting emotional characteristics of a facial image and providing raw data pertaining to emotional characteristics; a third image processing service component 17 to detect whether an image is a facial image or a non-facial image and providing a probability indication; and a fourth image processing service 17a which identifies what a non facial image may be.

These services include: a Face application programming interface (API) which provides information relating to physical characteristics of a face in an image (e.g. age, gender, are they smiling, etc.); an Emotion API which provides information relating to an emotional state of the person based on their face in the image (e.g. happy/sad/disgusted etc.); a Vision API which can identify objects in an image and thus can be used to identify that an image does or does not contain a face; and a Vision 2 API which identifies what non facial images may be.

The physical characteristic detecting component 13 analyses the image and outputs raw data pertaining to physical characteristics. The raw data may be in any suitable form. For example, it may be a simple output indicating a physical characteristic (e.g. “brown hair”) or it may be a more complicated output providing a more thorough analysis (e.g. “brown hair likelihood=99%, blonde hair likelihood=1%”). The behaviour of the Bot 36 can be adapted accordingly, as outlined in more detail below.

The emotional characteristics detecting component 15 analyses the image and outputs raw data pertaining to emotional characteristics. The raw data may be in any suitable form. For example, it may be a simple output indicating an emotional characteristic (e.g. “happy”) or it may be a more complicated output providing a more thorough analysis (e.g. “happy likelihood=98%, sad likelihood=1%, disgust likelihood=1%”). The behaviour of the Bot 36 can be adapted accordingly, as outlined in more detail below.

The facial characteristic detecting component 17 analyses the image and outputs an indication of whether an image is a facial image or a non-facial image which may take the form of a probability indication. The raw data may be in any suitable form. For example, it may be a simple output indicating whether or not there is a face present in the image (e.g. “yes”) or it may be a more complicated output providing a more thorough analysis (e.g. how many faces there are and/or likelihood of a face being present). The behaviour of the Bot 36 can be adapted accordingly, as outlined in more detail below.

As described above, the Bot 36 is thus provided with the output from the image processing service 11 indicating the raw data from the individual services (physical 13, emotional 15, and facial 17).

The image data can be sent to all the APIs simultaneously, for performance reasons. But the results are read in order: Vision, then Emotion, then Face. The reason the APIs are called simultaneously is so that if the Vision API says it's not a face (by generating a probability indication below a threshold), it doesn't have to wait to get the emotion or face data (which will be uninteresting since it's not a face). However, if a face has been recognised, there is no delay while calling the Face and Emotion APIs. It will be recognized that the services may be accessed in any suitable way and not necessarily through APIs.

Using the output from the image processing service 11, the Bot 36 constructs an appropriate response to provide to the user 4 through the communication event. For example, this response might be a text message that the user 4 can read via display 24, or the response may be an audio response for playing out to the user 4 in audible form via speaker 26.

To construct the message, the Bot 36 analyses the raw data from the image processing service 11. For example, taking the characteristics as determined as the most likely (or indicated explicitly, when the raw data does not indicate likelihoods) allows the Bot 36 to determine that the user 4 in the image is, for example, “happy, with long brown hair”. From this, the Bot 36 constructs a human-like reply to the user 4 (e.g. in full sentences) which may include a human-like comment (e.g. “I like your hair!”). The replies may, for example, be insults or compliments. The transformation of raw data to replies is done in the bot's code, using a set of rules which provide a phrase library 78 and a semantic library 80. When the code detects various features or characteristics in the image data it chooses from a list of phrases about each from the phrase library. There are a handful of features to comment on, and a handful of phrases for each, so many personalised responses can be generated by combining them all together in a randomised way. The sentences which constitute the humanly readable text messages are built using the same system as the individual phrases—arbitrarily chosen semantically equivalent sentences, which the phrases are formatted into.

This transformation could also be implemented using a lookup table of stock phrases which specifies a particular phrase for some or all facial features (e.g. a certain stock phrase for brown hair, another stock phrase for blonde hair, etc.). The transformation may also be implemented using machine learning. For example, users could rate the responses given by the Bot 36 (e.g. how funny the response was) and the Bot 36 can learn to improve the responses over time.

Note that while the transformation has been described herein generally in terms of software, it is appreciated that it may be implemented using hardware (e.g. bespoke hardware) or Programmable Silicon on Chip (PSoC).

The reply message determined by the Bot 36 is then provided to the user 4 via the communication event and thus displayed to the user 4 on display 24 (or output via speaker 26 in the case of an audio output).

The image processing service 11 may be embodied on multiple distinct servers each providing separate services. For example, each of the physical 13, emotional 15, and facial 17 analysis components may be run on a separate server. In this case, the Bot 36 is arranged to provide the user's image to each of the services separately. In this case, it may be preferable for the Bot 36 to first determine whether there is a face in the image (using facial service 17) first before running any other service on the image. This allows the Bot 36 to reject any images which do not contain faces and hence save the processing power and bandwidth needed to run the physical 13 and emotional 15 services. In these cases, the Bot 36 may provide a response to the user 4 indicating that their image does not contain a face, and may request that the user 4 try again.

The method may be implemented in a communication system, wherein the communication system comprises a user account database storing, for each of a plurality of users of the communication system, a user identifier that uniquely identifies that user within the communication system. A user identifier of the software agent may also be stored in the user account database so that the software agents appears as another user of the communication system.

Generally, any of the functions described herein can be implemented using software, firmware, hardware (e.g., fixed logic circuitry), or a combination of these implementations. The terms “module,” “functionality,” “component”, and “logic” as used herein—such as the functional modules in the FIGs herein—generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the remote system 8 or user terminal 6 may also include an entity (e.g. software) that causes hardware of the device or system to perform operations, e.g., processors functional blocks, and so on. For example, the device or system may include a computer-readable medium that may be configured to maintain instructions that cause the devices, and more particularly the operating system and associated hardware of device or system to perform operations. Thus, the instructions function to configure the operating system and associated hardware to perform the operations and in this way result in transformation of the operating system and associated hardware to perform functions. The instructions may be provided by the computer-readable medium to the display device through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the AI software agent may by implemented on an entity (e.g. software) that causes hardware of the user terminals to perform operations, e.g., processors functional blocks, and so on. For example, the AI software agent may be implemented on a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer program product comprising a software agent stored on computer readable storage, the software agent being configured when run on one or more processing devices to perform operations of:
receiving from a human user an image in a message within a communication event established between a user terminal associated with the human user and the software agent;
transmitting image data from the image to at least two image processing service components, including: (i) first image processing service component for detecting physical characteristics of a facial image and providing raw data pertaining to physical characteristics; and (ii) a second image processing service component for detecting emotional characteristics of a facial image and providing raw data pertaining to emotional characteristics;
processing the raw data from the first and second image processing service to generate humanly readable text for incorporation in a response message;
transmitting the response message in the communication event to the user terminal for display to a human user at the user terminal.

2. A computer program product according to claim 1, wherein the method comprises supplying the image data to (iii) a third image processing service component to detect whether an image is a facial image or a non-facial image and receiving a probability indication from the third image processing service, wherein the image data is supplied to the first and second image processing services only if the probability indication indicates a probability above a threshold that the image is a facial image; and wherein said processing comprises processing the raw data from the first and second image processing service and the probability indication from the third image processing service to generate the humanly readable text for incorporation in the response message.

3. A computer program product according to claim 2, wherein if the probability indication is below the threshold, the method comprises supplying the image data to a fourth image processing service which detects the nature of the image.

4. A computer program product according to claim 1, wherein the step of processing the raw data comprises extracting characteristics from the raw data based on categories of expected characteristics, and accessing a library of characteristic terms to generate a humanly readable phrase or word matching the characteristic.

5. A computer program product according to claim 4, wherein the method comprises accessing a semantics library of interconnecting phrases to generate the humanly readable text from the phrase or word.

6. A computer program product according to claim 1, wherein the method comprises establishing the communication event in response to receiving a request from the user terminal.

7. A computer program product according to claim 1, wherein the step of receiving the image data comprises extracting the image data from the received message.

8. A computer program product according to claim 1, wherein the step of extracting the image data comprises extracting an indication from the message and using the indication to access a remote source of the image data.

9. A computer device comprising a processor, a computer storage access component and a communications interface, the processor configured to run a computer program stored on storage accessed by the storage access component comprising a software agent, the software agent being configured when run on one or more processing devices to perform operations of:
receiving via the communications interface from a human user an image in a message within a communication event established between a user terminal associated with the human user and the software agent;
transmitting image data from the image to at least two image processing service components, including: (i) first image processing service component for detecting physical characteristics of a facial image and providing raw data pertaining to physical characteristics; and (ii) a second image processing service component for detecting emotional characteristics of a facial image and providing raw data pertaining to emotional characteristics;
processing the raw data from the first and second image processing service to generate humanly readable text for incorporation in a response message;
transmitting the response message in the communication event to the user terminal for display to a human user at the user terminal.

10. A computer device according to claim 9, wherein the method comprises supplying the image data to (iii) a third image processing service component to detect whether an image is a facial image or a non-facial image and receiving a probability indication from the third image processing service, wherein the image data is supplied to the first and second image processing services only if the probability indication indicates a probability above a threshold that the image is a facial image; and wherein said processing comprises processing the raw data from the first and second image processing service and the probability indication from the third image processing service to generate the humanly readable text for incorporation in the response message.

11. A computer device according to claim 10, wherein if the probability indication is below the threshold, the method comprises supplying the image data to a fourth image processing service which detects the nature of the image.

12. A computer device according to claim 9, wherein the step of processing the raw data comprises extracting characteristics from the raw data based on categories of expected characteristics, and accessing a library of characteristic terms to generate a humanly readable phrase or word matching the characteristic, the library accessible via the storage access component.

13. A computer device according to claim 12, wherein the method comprises accessing a semantics library of interconnecting phrases to generate the humanly readable text from the phrase or word.

14. A computer device according to claim 9, wherein the method comprises establishing the communication event in response to receiving a request from the user terminal.

15. A computer device according to claim 9, wherein the step of receiving the image data comprises extracting the image data from the received message.

16. A computer device according to claim 9, wherein the step of extracting the image data comprises extracting an indication from the message and using the indication to access a remote source of the image data.

17. A method implemented by a computer program product comprising a software agent stored on computer readable storage, the method comprising:
receiving from a human user an image in a message within a communication event established between a user terminal associated with the human user and the software agent;
transmitting image data from the image to at least two image processing service components, including: (i) first image processing service component for detecting physical characteristics of a facial image and providing raw data pertaining to physical characteristics; and (ii) a second image processing service component for detecting emotional characteristics of a facial image and providing raw data pertaining to emotional characteristics;
processing the raw data from the first and second image processing service to generate humanly readable text for incorporation in a response message;
transmitting the response message in the communication event to the user terminal for display to a human user at the user terminal.

18. A method according to claim 17, wherein the method comprises supplying the image data to (iii) a third image processing service component to detect whether an image is a facial image or a non-facial image and receiving a probability indication from the third image processing service, wherein the image data is supplied to the first and second image processing services only if the probability indication indicates a probability above a threshold that the image is a facial image; and wherein said processing comprises processing the raw data from the first and second image processing service and the probability indication from the third image processing service to generate the humanly readable text for incorporation in the response message.

19. A method according to claim 18, wherein if the probability indication is below the threshold, the method comprises supplying the image data to a fourth image processing service which detects the nature of the image.

20. A method according to claim 17, wherein the step of processing the raw data comprises extracting characteristics from the raw data based on categories of expected characteristics, and accessing a library of characteristic terms to generate a humanly readable phrase or word matching the characteristic.
